(19) United States
(12) Patent Application Publication
(10) Pub. No.: US 2025/0086005 A1
(43) Pub. Date: Mar. 13, 2025

(54) DIGITAL TWIN-BASED EDGE-END COLLABORATIVE SCHEDULING METHOD FOR HETEROGENEOUS TASKS AND RESOURCES

(71) Applicant: SHENYANG INSTITUTE OF AUTOMATION , CHINESE ACADEMY OF SCIENCES, Shenyang, Liaoning (CN)

(72) Inventors: Chi XU, Shenyang, Liaoning (CN); Haibin YU, Shenyang, Liaoning (CN); Xi JIN, Shenyang, Liaoning (CN); Changqing XIA, Shenyang, Liaoning (CN); Dong LI, Shenyang, Liaoning (CN); Peng ZENG, Shenyang, Liaoning (CN)

(21) Appl. No.: 18/294,391

(22) PCT Filed: Jul. 5, 2023
(86) PCT No.: PCT/CN2023/105898

§ 371 Date: Feb. 1, 2024

(30) Foreign Application Priority Data
Jan. 31, 2023 (CN) 202310046985.0

(51) Int. Cl. G06F 9/48; G06F 9/50

(52) U.S. Cl. CPC G06F 9/4881; G06F 9/5083

(57) ABSTRACT

A digital twin-based edge-end collaborative scheduling method for heterogeneous tasks and resources includes the following steps: establishing an edge wireless network based on digital twin; constructing an edge-end collaborative scheduling problem prototype of the heterogeneous tasks and resources; performing problem conversion based on a multi-agent Markov decision process; constructing an Actor-Critic neural network model based on multi-agent deep reinforcement learning; performing offline centralized training of the neural network model by digital twin; performing online distributed execution of task offloading and computation and communication resource allocation by end devices to collaboratively process the heterogeneous tasks. The method optimizes the heterogeneous computation resource types, the task offloading ratio, the transmit power of the end devices and the computation resource allocation ratio of edge servers through digital twin, supports the on-demand offloading of heterogeneous tasks, realizes edge-end collaborative computing, and minimizes the total task processing delay.

### TECHNICAL FIELD

The present invention relates to the field of wireless networks, in particular to a digital twin-based edge-end collaborative scheduling method for heterogeneous tasks and resources.

### BACKGROUND

With the rapid development of 5G, more and more devices have been connected to the Internet, as a result of which people, machines and things are connected to each other to realize the Internet of everything. Therefore, the transmission of large-scale heterogeneous tasks on 5G networks is explosive. Typical heterogeneous tasks include: video/media tasks that require broadband communications, sensing/measurement tasks that require low-power communications, and industrial control tasks that require real-time computation and deterministic communications. To complete a complex task, multiple heterogeneous tasks shall be coordinated. When these heterogeneous tasks perform highly concurrent access, they must compete for limited communication resources in the “spatio-temporal-frequency” domain, thereby causing transmission conflicts and reducing QoS.

To improve the quality of service (QoS), multi-access edge computing can be used to assist in processing the tasks of end devices, so as to reduce task processing delay. Typically, an edge server is deployed on a base station, and the base station can achieve some network management functions and provide computing power resources for the end devices to assist computing to reduce the task processing delay. However, the multi-access edge computing may further aggravate the problem of competition for the communication resources. Especially, heterogeneous industrial tasks have different demands on computation and communication resources, resulting in fragmentation of the resources. Therefore, according to the demands on the heterogeneous tasks, reasonable scheduling of the computation and communication resources of the end devices and the edge servers is the current core challenge.

The existing methods face different multi-access edge computing scenarios, adopt different optimization algorithms or theories, and optimize different parameters to achieve different objectives such as delay minimization, energy consumption minimization and throughput maximization. However, the existing methods do not pay attention to the problems of matching of heterogeneous computation resource types, mutual interference of devices during computing offloading, and the error of resource estimation.

### SUMMARY

The present invention is oriented to the generalized scenarios with a single cloud server, multiple edge servers, and multiple end devices, adopts the digital twin technology to virtualize and model heterogeneous computation resources, and can support collaborative scheduling of heterogeneous tasks, heterogeneous computation resources and communication resources. The present invention fully considers the deadline requirements and the required computation resource types of the heterogeneous tasks, the computation resource types and the maximum computing capacity of end devices and edge servers, the estimation deviations of computation resources of digital twin, the maximum transmit power and the peak interference power of the end devices, and proposes an edge-end collaborative scheduling method for heterogeneous tasks and network computation and communication resources based on multi-agent deep reinforcement learning, which solves the problem that the traditional scheduling method is difficult to deal with the state space explosion under a dynamic network environment, achieves the minimization of the total processing delay of the heterogeneous tasks, and can support real-time collaborative processing of heterogeneous high-concurrency tasks such as computation intensive tasks and delay sensitive tasks.

To achieve the above purpose, the present invention adopts the following technical solution: a digital twin-based edge-end collaborative scheduling method for heterogeneous tasks and computation and communication resources by multi-agent deep reinforcement learning, and comprises the following steps:
1) establishing an edge wireless network based on digital twin;
2) constructing an edge-end collaborative scheduling problem of heterogeneous tasks and resources according to the deadline requirements of the heterogeneous tasks and the constraints of the heterogeneous computation and communication resources;
3) converting the scheduling problem into a multi-agent Markov decision process problem;
4) constructing an Actor-Critic neural network model based on the multi-agent deep reinforcement learning to solve the multi-agent Markov decision process problem;
5) performing offline centralized training of the Actor-Critic neural network model by digital twin to obtain an experience pool and neural network parameters;
6) perceiving an environment state online by end devices, and performing distributed allocation of task offloading and computation and communication resource according to the Actor-Critic neural network model under centralized training to collaboratively process the heterogeneous tasks and minimize the total delay of task processing.

The edge wireless network based on digital twin comprises: N base stations configured with edge servers and M end devices;

The base stations are configured with edge servers and used for providing computation resources for a plurality of end devices and supporting scheduling of the end devices within a coverage range;

The end devices are used for computing the heterogeneous tasks locally, and supporting offloading of the heterogeneous tasks to the edge servers through wireless channels for edge computing;

The digital twin is placed on a cloud server of the network, represented as a virtualization model established by the base stations and the end devices comprised in the network, and used for evaluating the operating states of the base stations, the edge server and the end devices, the types of the computation resources, and the amount of the computation and communication resources, and supporting the training of deep reinforcement learning methods to carry out the edge-end collaborative scheduling of the network.

For a single end device, the tasks can be non-offloaded, partially offloaded, or completely offloaded to one or more edge servers for computing;

The transmission rate of the end device during task offloading is

$${R}_{m , n} = {W}_{m , n} {log}_{2} ( 1 + \frac{{p}_{m} {g}_{m , n}}{{\sum }_{{m}^{′} = 1 , {m}^{′} \neq m}^{M} {p}_{{m}^{′}} {g}_{{m}^{′} , n} + {σ}_{n}^{2}} )$$

wherein W_{m,n} represents the bandwidth between the end device m and the edge server n, σₙ² represents the noise at the edge server n, g_{m,n} and g_{m′,n} represent channel power gains from the end device m and the end device m′ to the edge server n respectively; and pₘ and p_{m′}, represent the transmit power of the end device m and the end device m′ respectively.

The edge-end collaborative scheduling problem of the heterogeneous tasks and resources is

$${min}_{U , V , P , F} {\sum }_{m = 1}^{M} {T}_{m} ,$$

$$s . t . C 1 : {\sum }_{n = 0}^{N} {v}_{m , n} = 1 ,$$

$$C 2 : 0 \leq {p}_{m} \leq {P}_{max} , m = 1 , … M ,$$

$$C 3 : {p}_{m} \leq \frac{{I}_{p} - {\sum }_{{m}^{′} = 1 , {m}^{′} \neq m}^{M} {p}_{{m}^{′}} {g}_{{m}^{′} , {m}^{*}}}{{g}_{m , {m}^{*}}} ,$$

$$C 4 : {u}_{m , n} = \{ \begin{matrix}1 , & if {o}_{n} ⊗ {o}_{m} = 0 , \\ 0 , & if {o}_{n} ⊗ {o}_{m} = 1 ,\end{matrix}$$

$$C 5 : 0 \leq {f}_{m , n} + Δ {f}_{m , n} \leq {F}_{max , n} ,$$

$$C 6 : {\sum }_{m = 1}^{M} {u}_{m , n} ( {f}_{m , n} + Δ {f}_{m , n} ) \leq {F}_{max , n} ,$$

$$C 7 : {T}_{m} \leq {T}_{max , m}$$

wherein

$${min}_{U , V , P , F} {\sum }_{m = 1}^{M} {T}_{m}$$

is the target of the problem, which represents minimization of the total task processing delay; Tₘ represents the task processing delay of the end device m; U, V, P and F are the sets of variables to be optimized in the problem, and represent the matching decision of the computation resource types, task offloading ratio, the transmit power of the end device and the computation resource allocation of the edge server respectively;

C1 is the constraint of the task offloading ratio; wherein v_{m,n}∈[0,1] is the task offloading ratio of the end device m to the edge server n; v_{m,n}=0 represents that the end device m does not offload tasks to the edge server n; v_{m,n}=1 represents that the end device m offloads tasks to the edge server n; v_{m,0}=0 represents that the end device m does not perform local computing; and v_{m,0}=1 represents that the end device m performs local computing;

C2 and C3 are the constraints of the transmit power of the end devices; wherein Pₘₐₓ represents the maximum transmit power of the end device; Iₚ represents the peak interference power that the end device can tolerate; and g_{m,m*} and g_{m′,m*} represent the channel gains from the end device m and the end device m′ to the end device m* respectively; wherein m*=arg max g_{m,m′} is the end device that generates the biggest interference to the end device m;

C4 is the matching decision constraint of the heterogeneous computation resource type; wherein Oₘ and Oₙ represent the computation resource types of the end device m and the edge server n respectively; ⊗ represents XOR operation; u_{m,n}=1 represents that the computation resource types of the end device m and the edge server n are the same; u_{m,n}=0 represents that the computation resource types of the end device m and the edge server n are different;

C5 and C6 are computation resource constraints; wherein f_{m,n} represents the edge computation resource estimated by the digital twin; Δf_{m,n} represents the computation resource estimation deviation of the digital twin; F_{max,n} represents the maximum computation rate of the edge server n;

C7 is a task deadline constraint; wherein T_{max,n} represents the deadline of the task executed by the end device m, that is, the longest task processing delay that can be accepted by the end device m.

The task processing delay of the end device is determined by the edge computing delay Tₙ^{Edge} and the local computing delay Tₘ^{Local}, and the computation method is as follows:

$${T}_{m} = max ( {T}_{m}^{Edge} , {T}_{m}^{Local} )$$

The edge computing delay Tₘ^{Edge} is computed as

$${T}_{m}^{Edge} = {max}_{n = 1 , … , N} \{ {u}_{m , n} {T}_{m , n}^{Edge} \}$$

wherein T_{m,n}^{Edge} represents the edge computing delay of the edge server n for the end device m which is determined by the communication delay T_{m,n}^{Comm} of task offloading and the computing delay T_{m,n}^{Comm} of task processing, and computed as

$${T}_{m , n}^{Edge} = {T}_{m , n}^{Comm} + {T}_{m , n}^{Comp}$$

The communication delay T_{m,n}^{Comm} of task offloading is determined by the task offloading amount and the offloading rate of the end device, and computed as

$${T}_{m , n}^{Comm} = \frac{{v}_{m , n} {D}_{m}}{{R}_{m , n}}$$

wherein Dₘ represents the task size of the end device m;

The computing delay T_{m,n}^{Comp} of the task processing is determined by the task offloading amount of the end device m and the computation resources n allocated by the edge server m for the end device f_{m,n}, and calculated as

$${T}_{m , n}^{Comp} = {\tilde{T}}_{m , n}^{Comp} + Δ {T}_{m , n}^{Comp}$$

\tilde{T}_{m,n}^{Comp} is the edge computing delay estimated by the digital twin, and calculated as

$${\tilde{T}}_{m , n}^{Comp} = \frac{{v}_{m , n} {D}_{m} {C}_{m}}{{f}_{m , n}}$$

wherein Cₘ represents a computation period required to compute a 1-byte task;
   ΔT_{m,n}^{Comp} is the deviation between the computed delay and the estimated delay, and calculated as

$$Δ {T}_{m , n}^{Comp} = - \frac{{v}_{m , n} {D}_{m} {C}_{m} Δ {f}_{m , n}}{{f}_{m , n} ( {f}_{m , n} + Δ {f}_{m , n} )}$$

The local computing delay Tₘ^{Local} is calculated as

$${T}_{m}^{Local} = {\tilde{T}}_{m}^{Comp} + Δ {T}_{m}^{Comp}$$

\tilde{T}ₘ^{Comp} is the local computing delay estimated by the digital twin, and calculated as

$${\tilde{T}}_{m}^{Comp} = \frac{{v}_{m , 0} {D}_{m} {C}_{m}}{{f}_{m}}$$

wherein fₘ=F_{max,m}−Δfₘ represents the local computation resource;
   ΔTₘ^{Comp} is the local computing delay deviation, and calculated as

$$Δ {T}_{m}^{Comp} = - \frac{{v}_{m , 0} {D}_{m} {C}_{m} Δ {f}_{m}}{{f}_{m} {F}_{max , m}} .$$

Converting the optimization scheduling problem into a multi-agent Markov decision process problem comprises the following steps:
a) establishing a multi-agent Markov decision model, comprising an agent set, a state space, an action space, a state transfer probability and a reward function;

The agent set is an agent set M={1 . . . ,M}formed by M end devices; The state space is a state of the agent m at time t, expressed as

$${s}_{m} ( t ) = \{ {D}_{m} ( t ) , {C}_{m} ( t ) , {T}_{max , m} ( t ) , Δ {f}_{m} ( t ) , {Δ}_{m}^{Edge} ( t ) , {W}_{m} ( t ) , {G}_{m} ( t ) \}$$

wherein Dₘ(t) represents the task size of the end device m; Cₘ(t) represents the number of computing cycles required by the end device m; T_{max,m}(t) represents the task deadline of the end device m; Δfₘ(t) represents the estimation deviation of the local computation resources of the end device m; Δₘ^{Edge}(t)={Δf_{m,1}(t), . . . , Δf_{m,N}(t)} represents the computation resource estimation deviation for N edge servers of the end device m; Wₘ(t)={W_{m,1}(t), . . . , W_{m,N}(t)} and Gₘ(t)={g_{m,1}(t), . . . , g_{m,N}(t)} represent the bandwidth and the channel gain between the end device m and N edge servers respectively; the total state space of all agents in time t is s(t)={s₁(t), . . . S_{M}(t)};

The action space is an action performed by the agent m at time t, expressed as

$${a}_{m} ( t ) = \{ {u}_{m} ( t ) , {v}_{m} ( t ) , {p}_{m} ( t ) , {f}_{m} ( t ) \}$$

wherein uₘ(t)={u_{m,1}(t), . . . ,u_{m,N}(t)} represents the matching decision of the computation resource types to judge whether the computation resource types of the edge servers are consistent with that of the end device m; vₘ(t)={v_{m,0}(t), v_{m,1}(t), . . . , v_{m,N}(t)} represents the offloading ratio of task processed between the end device m and N edge servers; pₘ(t) represents the transmit power of the end device m for task offloading; fₘ (t)={f_{m,1}(t), . . . , f_{m,N}(t)} represents the computation resources allocated by N edge servers for the end devices m; the total action space of all agents at time t is a(t)={a₁(t), . . . a_{M}(t)};

The state transfer probability is the probability transferred by Sₘ(t) to Sₘ(t+1) when the agent m executes an action aₘ(t), that is, zₘ(sₘ(t+1);sₘ(t),aₘ(t));

The reward function is the reward or punishment for the agent to take the action in a certain set state, expressed as rₘ(t); wherein the individual reward obtained by the agent m is rₘ(t)=rₘ^{Latency}(t)+ρₘrₘ^{DDL}(t), and ρₘ represents a weight parameter set according to the deadline requirement of the heterogeneous tasks; the delay reward is rₘ^{Latency}(t)=−Tₘ(t) and the deadline reward is rₘ^{DDL}(t)=T_{max,m}(t)−Tₘ(t);
b) determining a long-term cumulative reward function as

$${R}_{m} ( t ) = {\sum }_{{t}_{0} = 0}^{t} {γ}_{m}^{{t}_{0}} {r}_{m} ( {t}_{0} )$$

wherein t represents the current time, t₀ represents the previous time, and γₘ∈[0,1] represents a discount coefficient for indicating the influence of past rewards on the current rewards of the agent m;
c) converting the problem into

max Rₘ(t)

s.t. C1,C2,C3,C4,C5,C6

In the case that the constraints C1-C6 are satisfied, the long-term cumulative reward is maximized to obtain the best state transfer probability, and then obtain the strategy of minimizing the total task processing delay.

Constructing an Actor-Critic neural network model based on the multi-agent deep reinforcement learning comprises an Actor network and a Critic network;

The Actor network adopts strategy-based deep neural networks, comprising an estimation Actor network for training and a target Actor network for executing the action to generate agent actions;

The Critic network adopts value-based deep neural networks, comprising an estimation Critic network and a target Critic network to evaluate the actions of the Actor and guide the Actor to produce better actions.

Performing offline centralized training of the neural network model by digital twin comprises the following steps:
a) inputting Sₘ(t) to the estimation Actor network to obtain aₘ(t)=πₘ (sₘ(t);θ_{π}_{ₘ}), wherein πₘ represents the strategy to take action aₘ(t), and θ_{π}_{ₘ}, represents a parameter of the estimation Actor network;
b) in state sₘ(t), executing the action aₘ(t), and computing the reward rₘ(t) to obtain sₘ(t+1);
c) (sₘ(t),a (t),rₘ (t),sₘ(t+1)) as an experience is stored in the experience pool for playback as the experience;
d) extracting the experience randomly from the experience pool, inputting S and A to the estimation Critic network, and computing the Q value Qₘ(S, A;θ_{Q}_{ₘ}) of the agent m; inputting s′ and A′ to the target Critic network, and computing the Q value Qₘ′(S′,A′;θ_{Q}_{ₘ}′) of the agent m at the next time, wherein S and S′ represent the states of all the agents and the state of the next time respectively; A and A′ represent the actions of all the agents and the action of the next time respectively; and θ_{Q}_{ₘ} and θ_{Q}_{ₘ}′ represent the parameters of the estimation Critic network and the target Critic network respectively;
e) computing a temporal difference error δ and a loss function L(θ_{Q}_{ₘ});
f) computing

$${∇}_{{θ}_{{Q}_{m}}} L ( {θ}_{{Q}_{m}} ) = E [ 2 δ {∇}_{{θ}_{{Q}_{m}}} {Q}_{m} ( S , A ; {θ}_{{Q}_{m}} ) ] ,$$

and updating the parameter θ_{Q}_{ₘ}, wherein [symbol] represents the random gradient descent computation of the loss function L(θ_{Q}_{ₘ}) under the parameter θ_{Q}_{ₘ}, and E[ ] represents an expected calculation value;
g) inputting sₘ(t) to the estimation Actor network to obtain aₘ(t)=πₘ (sₘ(t);θ_{π}_{ₘ}); and inputting sₘ(t+1) to the target Actor network to obtain aₘ (t+1)=πₘ′(sₘ (t+1);θ_{π}_{ₘ}′) wherein πₘ′ represents the strategy to take the action aₘ(t+1), and θ_{π}_{ₘ}′ represents the parameter of the target Actor network;
h) computing

$${∇}_{{θ}_{{π}_{m}}} L ( {θ}_{{π}_{m}} ) \approx E [ {∇}_{{θ}_{{π}_{m}}} log {π}_{m} ( {s}_{m} ( t ) ; {θ}_{{π}_{m}} ) {Q}_{m} ( S , A ; {θ}_{{Q}_{m}} ) ] ,$$

and updating the parameter θ_{π}_{ₘ}, wherein [symbol] represents the random gradient descent computation of the loss function L(θ_{π}_{ₘ}) under the parameter θ_{π}_{ₘ};
i) updating θ_{π}_{ₘ}′ and θ_{Q}_{ₘ}′ according to θ_{Q}_{ₘ}′=ηθ_{Q}_{ₘ}+(1−η)θ_{Q}_{ₘ}′ and θ_{π}_{ₘ}′=ηθ_{π}_{ₘ}+(1−η)θQ_{π}_{ₘ}′, wherein η∈[0,1] represents the update rate of the parameter;
j) repeating and iterating steps a)-i) to preset training times to obtain the trained experience pool and the neural network model parameters θ_{Q}_{ₘ} and θ_{π}_{ₘ} as the offline centralized training results of the digital twin.

Perceiving an environment state online by end devices, and performing distributed execution of task offloading and computation and communication resource allocation according to the Actor-Critic neural network model under centralized training comprises the following steps:
a) downloading the offline centralized training results of the digital twin by all agents;
b) perceiving an environment by all the agents to obtain respective states, computing respective rewards according to the trained neural network parameters, and executing actions online in a distributed mode, wherein after the state Sₘ(t) of the agent m is inputted to the target Actor network, the action aₘ(t) is outputted according to the reward rₘ(t), that is, the matching decision result of the computation types, the task offloading ratio, the transmit power and the computation resource allocation result of the end device m and N edge servers;
c) performing task offloading and collaborative computing by all end devices according to the output actions of respective neural networks, that is, the scheduling results of the heterogeneous tasks and resources.

The present invention has the following beneficial effects and advantages:

1. With respect to the edge-end collaborative processing problem of heterogeneous high-concurrency tasks, the present invention fully considers the deadline requirements and computation resource types of the heterogeneous tasks, the maximum computing capacity of end devices and edge servers, the estimation deviations of computation resources of digital twin, the maximum transmit power of the end devices and the peak interference power of the end devices, and proposes a digital twin-based edge-end collaborative scheduling method for heterogeneous tasks and resources, which can satisfy the QoS requirements of the heterogeneous tasks and support the edge-end collaborative processing of the heterogeneous tasks.

2. With respect to the problems of difficult modeling and algorithm state space explosion caused by complicated coupling of heterogeneous computation and communication multidimensional resources, the present invention adopts the multi-agent deep reinforcement learning method to propose the digital twin-based edge-end collaborative scheduling method for heterogeneous tasks and resources, which achieves centralized offline training and distributed online execution of the scheduling algorithm, can minimize the total processing delay of the tasks, and simultaneously satisfies different deadline requirements of the heterogeneous tasks.

### DESCRIPTION OF DRAWINGS

FIG. 1 is a flow chart of a method of the present invention;

FIG. 2 is a schematic diagram of a scenario with a single cloud server, multiple edge servers and multiple end devices with digital twin;

FIG. 3 is a structural diagram of an Actor network adopted by the present invention;

FIG. 4 is a structural diagram of a Critic network adopted by the present invention;

FIG. 5 is a flow chart of deep reinforcement learning training in the present invention.

### DETAILED DESCRIPTION

The present invention will be further described in detail below in combination with the drawings and the embodiments.

The present invention is oriented to the edge-end collaborative processing of large-scale heterogeneous tasks under the scenarios with a single cloud server, multiple edge servers and multiple end devices, and proposes an edge-end collaborative scheduling method for heterogeneous tasks and network computation and communication resources based on multi-agent deep reinforcement learning. The method of the present invention can support the on-demand offloading of the heterogeneous tasks and realize edge-end resource collaboration. On the premise of satisfying the limitations such as deadline requirements and computation resource types of the heterogeneous tasks, the maximum computing capacity of end devices and edge servers, the estimation deviations of computation resources of digital twin, the maximum transmit power of the end devices and the peak interference power of the end devices, the present invention achieves the minimization of the total processing delay of the heterogeneous tasks and supports the edge-end collaborative processing of the heterogeneous tasks.

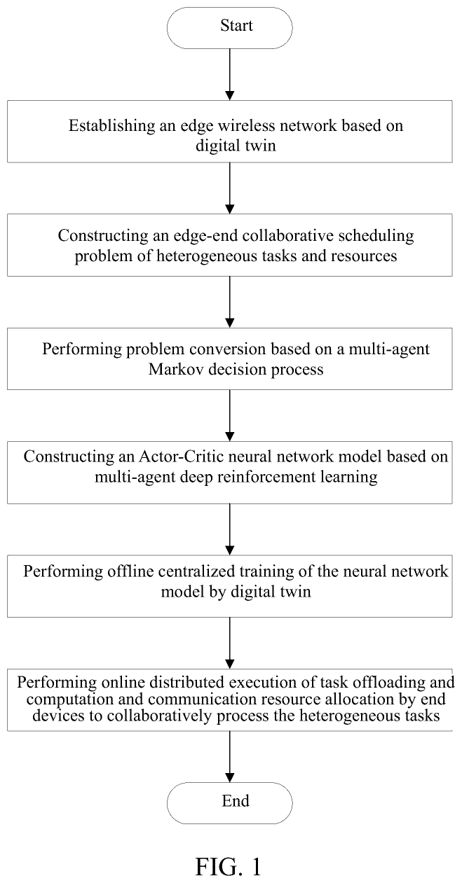

The digital twin-based edge-end collaborative scheduling method for heterogeneous tasks and resources proposed by the present invention comprises the following steps: 1) establishing an edge wireless network based on digital twin; 2) constructing an edge-end collaborative scheduling problem of heterogeneous tasks and resources according to the deadline requirements of the heterogeneous tasks and the constraints of the heterogeneous computation and communication resources; 3) converting the scheduling problem into a multi-agent Markov decision process problem; 4) constructing an Actor-Critic neural network model based on the multi-agent deep reinforcement learning to solve the multi-agent Markov decision process problem; 5) performing offline centralized training of the Actor-Critic neural network model by digital twin to obtain an experience pool and neural network parameters; and 6) performing online distributed execution of task offloading and computation and communication resource allocation by end devices to collaboratively process the heterogeneous tasks and minimize the total task processing delay. The overall flow of the present invention is shown in FIG. 1.

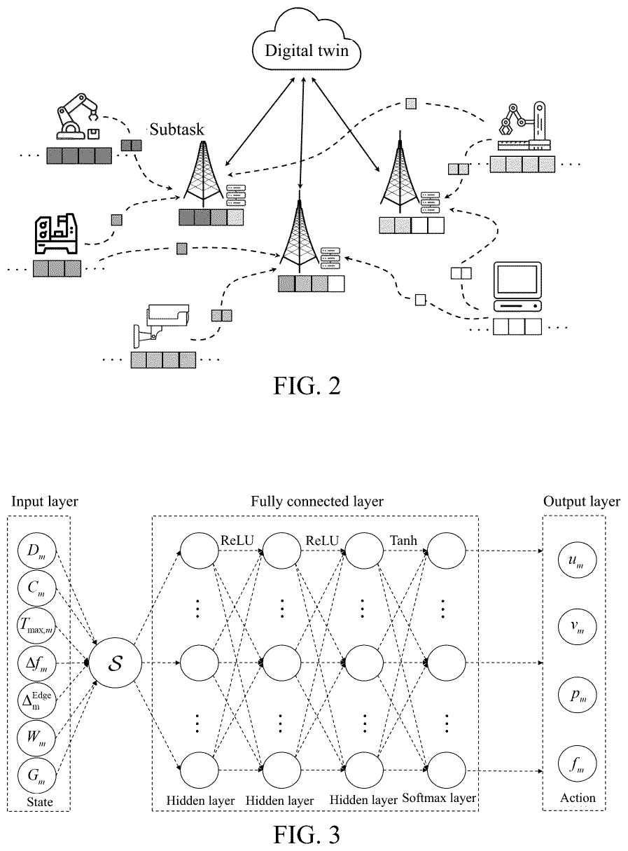

1) The edge wireless network based on digital twin is established. As shown in FIG. 2, the physical space has a cloud server, N base stations configured with edge servers and M end devices, wherein a digital twin is deployed on the cloud server and can mirror all network elements, model the network space, perceive heterogeneous tasks, measure heterogeneous computation and communication resources, train scheduling algorithms and schedule tasks and resources. The base station is configured with the edge server for providing computation resources for a plurality of end devices and supporting the scheduling of the end devices within the coverage range. The end devices are used to compute heterogeneous tasks locally, and support the heterogeneous tasks offloading to the edge servers through wireless channels for edge computing.

For a single end device, the tasks can be non-offloaded, partially offloaded, or completely offloaded to one or more edge servers for computing. The transmission rate of the end device during task offloading is

$${R}_{m , n} = {W}_{m , n} {log}_{2} ( 1 + \frac{{p}_{m} {g}_{m , n}}{{\sum }_{{m}^{′} = 1 , {m}^{′} \neq m}^{M} {p}_{{m}^{′}} {g}_{{m}^{′} , n} + {σ}_{n}^{2}} )$$

wherein W_{m,n} represents the bandwidth between the end device m and the edge server n, σₙ² represents the noise at the edge server n, g_{m,n} and g_{m′,n} represent channel power gains from the end device m and the end device m′ to the edge server n respectively; and pₘ and P_{m′} represent the transmit power of the end device m and the end device m′ respectively.

2) An edge-end collaborative scheduling problem of heterogeneous tasks and resources is constructed.

The task processing delay Tₘ of the end device is determined by the edge computing delay Tₘ^{Edge} and the local computing delay Tₘ^{Local}, and a computation method is as follows:

$${T}_{m} = max ( {T}_{m}^{Edge} , {T}_{m}^{Local} )$$

a) The edge computing delay Tₘ^{Edge} is computed as

$${T}_{m}^{Edge} = {max}_{n - 1 , … , N} \{ {u}_{m , n} {T}_{m , n}^{Edge} \}$$

wherein T_{m,n}^{Edge} represents the edge computing delay of the edge server n for the end device m, which is determined by the communication delay T_{m,n}^{Comm} and the computing delay T_{m,n}^{Comp} and computed as

$${T}_{m , n}^{Edge} = {T}_{m , n}^{Comm} + {T}_{m , n}^{Comp}$$

The communication delay T_{m,n}^{Comm} of edge computing is determined by the task offloading amount and the offloading rate of the end device, and computed as

$${T}_{m , n}^{Comm} = \frac{{v}_{m , n} {D}_{m}}{{R}_{m , n}}$$

wherein Dₘ represents the task size of the end device m;

The computing delay Tₘ^{Comp} of the edge computing is determined by the task offloading amount of the end device m and the computation resources f_{m,n} allocated by the edge server n for the end device m, and calculated as

$${T}_{m , n}^{Comp} = {\tilde{T}}_{m , n}^{Comp} + Δ {T}_{m , n}^{Comp}$$

\tilde{T}_{m,n}^{Comp} is the edge computing delay estimated by the digital twin, and calculated as

$${\tilde{T}}_{m , n}^{Comp} = \frac{{v}_{m , n} {D}_{m} {C}_{m}}{{f}_{m , n}}$$

wherein Cₘ represents a computation period required to compute a 1-byte task;
   ΔT_{m,n}^{Comp} is the deviation between the computed delay and the estimated delay, and calculated as

$$Δ {T}_{m , n}^{Comp} = - \frac{{v}_{m , n} {D}_{m} {C}_{m} Δ {f}_{m , n}}{{f}_{m , n} ( {f}_{m , n} + Δ {f}_{m , n} )}$$

b) The local computing delay Tₘ^{Local} is calculated as

$${T}_{m}^{Local} = {\tilde{T}}_{m}^{Comp} + Δ {T}_{m}^{Comp}$$

\tilde{T}ₘ^{Comp} is the local computing delay estimated by the digital twin, and calculated as

$${\tilde{T}}_{m}^{Comp} = \frac{{v}_{m , 0} {D}_{m} {C}_{m}}{{f}_{m}}$$

wherein fₘ=F_{max,m}−Δfₘ represents the local computation resource;
   ΔTₘ^{Comp} is the local computing delay deviation, and calculated as

$$Δ {T}_{m}^{Comp} = - \frac{{v}_{m , 0} {D}_{m} {C}_{m} Δ {f}_{m}}{{f}_{m} {F}_{max , m}}$$

Constructing a joint scheduling problem of heterogeneous tasks and network computation and communication resources with minimization of total task processing delay as the target according to the deadline requirements of the heterogeneous tasks and the constraints of the heterogeneous computation and communication resources is as follows:

$${min}_{U , V , P , F} {\sum }_{m = 1}^{M} {T}_{m} ,$$

$$s . t . C 1 : {\sum }_{n = 0}^{N} {v}_{m , n} = 1 ,$$

$$C 2 : 0 \leq {p}_{m} \leq {P}_{max} ,$$

$$m = 1 , … M ,$$

$$C 3 : {p}_{m} \leq \frac{{I}_{p} - {\sum }_{{m}^{′} = 1 , {m}^{′} \neq m}^{M} {p}_{{m}^{′}} {g}_{{m}^{′} , {m}^{*}}}{{g}_{m , {m}^{*}}}$$

$$C 4 : {u}_{m , n} = \{ \begin{matrix}1 , if {o}_{n} ⊗ {o}_{m} = 0 , \\ 0 , if {o}_{n} ⊗ {o}_{m} = 1 ,\end{matrix}$$

$$C 5 : 0 \leq {f}_{m , n} + Δ {f}_{m , n} \leq {F}_{max , n} ,$$

$$C 6 : {\sum }_{m = 1}^{M} {u}_{m , n} ( {f}_{m , n} + Δ {f}_{m , n} ) \leq {F}_{max , n} ,$$

$$C 7 : {T}_{m} \leq {T}_{max , m}$$

wherein U, V, P, F are the sets of variables to be optimized in the problem, and represent the matching decision of the computation resource types, task offloading ratio, the transmit power of the end device and the computation resource allocation of the edge server respectively;

$${min}_{U , V , P , F} {\sum }_{m = 1}^{M} {T}_{m}$$

is the target of the problem, i.e., minimization of the completion time for the total task;
C1 is the constraint of the task offloading ratio; wherein v_{m,n}∈[0,1]e end device m to the edge server n; v_{m,n}=0 represents that the end device m does not migrate tasks to the edge server n; v_{m,n}=1 represents that the end device m migrates tasks to the edge server n; v_{m,0}=0 represents that the end device m does not perform local computing; and v_{m,0}=1 represents that the end device m performs local computing;
C2 and C3 are the constraints of the transmit power; wherein Pₘₐₓ represents the maximum transmit power of the end device; Iₚ represents the peak interference power that the end device can tolerate; and g_{m,n*} and g_{m′,m*} represent the channel gains from the end device m and the end device m′ to the end device m* respectively. wherein m*=arg max g_{m,m′}. is the end device that generates the biggest interference constrain for the end device m
C4 is the matching decision constraint of the heterogeneous computation resource type; wherein Oₙ and Oₘ represent the computation resource types of the end device m and the edge server n respectively; ⊗ represents XOR operation; u_{m,n}=1 represents that the computation resource types of the end device m and the edge server n are the same; u_{m,n}=0 represents that the computation resource types of the end device m and the edge server n are different;
C5 and C6 are computation resource constraints; wherein f_{m,n} represents an edge computation resource estimated by the digital twin; Δf_{m,n} represents that the digital twin possibly has the computation resource estimation deviation; F_{max,n} represents the maximum computation rate of the edge server n;
C7 is a task deadline constraint; wherein T_{max,m} represents the deadline of the task executed by the end device m, that is, the longest task processing time that can be accepted by the end device m.
3) The problem is converted based on a multi-agent Markov decision process.
a) establishing a multi-agent Markov decision model, comprising an agent set, a state space, an action space, a state transfer probability and a reward function;
The agent set is an agent set M={1, . . . , M}formed by M end devices; The state space is a state of the agent m at time t, expressed as

$${s}_{m} ( t ) = \{ {D}_{m} ( t ) , {C}_{m} ( t ) , {T}_{max . m} ( t ) , Δ {f}_{m} ( t ) , {Δ}_{m}^{Edge} ( t ) , {W}_{m} ( t ) , {G}_{m} ( t ) \}$$

wherein Dm(t) represents the task size of the end device m; Cₘ(t) represents the number of computing cycles required by the end device m; T_{max,n}(t) represents the task deadline of the end device m; Δfₘ(t) represents the estimation deviation of the local computation resources of the end device m; Δₘ^{Edge}(t); {Δf_{m,1}(t), . . . , Δf_{m,N}(t)} represents the computation resource estimation deviation for N edge servers of the end device m; Wₘ(t)={W_{m,1}(t), . . . , W_{m,N}(t)} and Gₘ (t)={g_{m,1}(t), . . . , g_{m,N}(t)}represent the bandwidth and the channel gain between the end device m and N edge servers respectively; the total state space of all agents in time t is s(t)={s₁(t), . . . S_{M}(t)};

The action space is an action performed by the agent m at time t, expressed as

$${a}_{m} ( t ) = \{ {u}_{m} ( t ) , {v}_{m} ( t ) , {p}_{m} ( t ) , {f}_{m} ( t ) \}$$

wherein uₘ(t)={u_{m,1}(t), . . . , u_{m,N}(t)} represents the matching decision of the computation resource types to judge whether the computation resource types of the edge servers are consistent with that of the end device m; vₘ(t)={v_{m,0}(t), v_{m,1}(t), . . . , v_{m,N}(t)} represents the ratio of task offloading processed between the end device m and N edge servers; pₘ(t) represents the transmit power of the end device m for task offloading; fₘ (t)={f_{m,1}(t) . . . f_{m,N}(t)} represents the computation resources allocated by N edge servers for the end devices m; the total action space of all agents at time t is a(t)={a₁(t), . . . a_{M}(t)}

The state transfer probability is the probability transferred by Sₘ(t) to Sₘ(t+1) when the agent m executes an action aₘ(t), that is, zₘ(sₘ(t+1);sₘ(t),aₘ(t));

The reward function is the reward or punishment for the agent to take the action in a certain set state, expressed as rₘ(t); wherein the individual reward obtained by the agent m is rₘ(t)=rₘ^{Latency}(t)+ρₘrₘ^{DDL}(t), and ρₘ represents a weight parameter set according to the deadline requirement of the heterogeneous tasks; the delay reward is rₘ^{Latency}(t)=−Tₘ(t) and the deadline reward is rₘ^{DDL}(t)32 T_{max,m}(t)−Tₘ(t);
b) determining a long-term cumulative reward function as

$${R}_{m} ( t ) = {\sum }_{{t}_{0} = 0}^{t} {γ}_{m}^{{t}_{0}} {r}_{m} ( {t}_{0} )$$

wherein t represents the current time, t₀ represents the previous time, and γₘ∈[0,1] represents a discount coefficient for indicating the influence of past rewards on the current rewards of the agent m;
c) converting the problem into

max Rₘ(t)

s.t. C1,C2,C3,C4,C5,C6

In the case that the constraints C1-C6 are satisfied, the long-term cumulative reward is maximized to obtain the best state transfer probability, and then obtain the strategy of minimizing the total task processing delay.

4) An Actor-Critic neural network model is constructed based on multi-agent deep reinforcement learning.

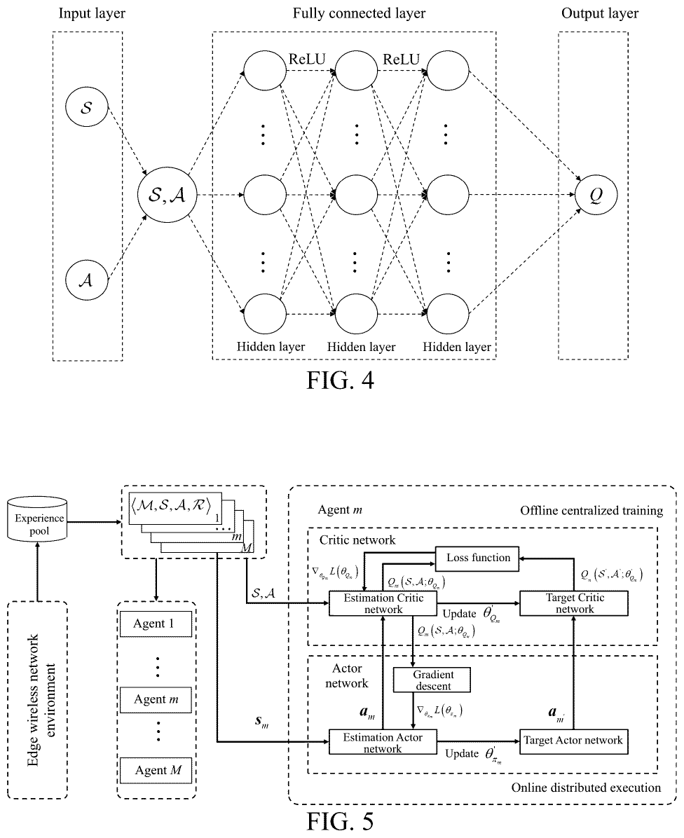

The Actor network and the Critic network are shown as FIG. 3 and FIG. 4 respectively. Actor is used to generate agent actions, and Critic is used to guide the Actor to produce better actions. The Actor network comprises an estimation Actor network for training and a target Actor network for executing the action; The Critic comprises an estimation Critic network and a target Critic network to evaluate the actions of the Actor.

wherein the Actor network adopts strategy-based deep neural networks, and the Critic network adopts value-based deep neural networks. The Actor network is composed of an input layer, three fully connected layers, a softmax layer and an output layer. For the first two hidden layers, the ReLU function is used as a nonlinear approximate activation function. For the last hidden layer, Tanh is used as the activation function to constrain the actions. Through the softmax layer, the output probability sum for each action is 1. Then, an action is selected as the final output action aₘ(t). The Critic network is composed of an input layer, three fully connected layers and an output layer, wherein the activation function of the first two hidden layers is ReLU.

5) Offline centralized training is performed for the neural network model by digital twin.

To obtain the strategy for minimization of the total task processing delay, as shown in FIG. 5, performing offline centralized training of the Actor-Critic neural network model by digital twin comprises the following steps:
a) inputting sₘ(t) to the estimation Actor network to obtain aₘ(t)=πₘ(sₘ(t);θ_{π}_{ₘ}), wherein πₘ represents the strategy to take action aₘ(t), and θ_{π}_{ₘ} represents a parameter of the estimation Actor network;
b) in state sₘ(t), executing the action aₘ(t), and computing the reward rₘ(t) to obtain sₘ(t+1);
c) (sₘ (t),aₘ(t),rₘ (t),sₘ(t+1)) as an experience is stored in the experience pool for playback as the experience;
d) extracting the experience randomly from the experience pool, inputting S and A to the estimation Critic network, and computing the Q value Qₘ (S, A;θ_{Q}_{ₘ}) of the agent m; inputting s′ and A′ to the target Critic network, and computing the Q value Qₘ′(S′,A′;θ_{Q}_{ₘ}′) of the agent m at the next time, wherein S and S′ represent the state of all the agents and the state of the next time respectively; A and A′ represent the action of all the agents and the action of the next time respectively; and θ_{Q}_{ₘ} and θ_{Q}_{ₘ}′ represent the parameters of the estimation Critic network and the target Critic network respectively;
e) computing a temporal difference error δ and a loss function L(θ_{Q}_{ₘ});
f) computing

$${∇}_{{θ}_{{Q}_{m}}} L ( {θ}_{{Q}_{m}} ) = E [ 2 δ {∇}_{{θ}_{{Q}_{m}}} {Q}_{m} ( S , A ; {θ}_{{Q}_{m}} ) ] ,$$

and updating the parameter θ_{Q}_{ₘ}, wherein [symbol] represents the random gradient descent computation of the loss function L(θ_{Q}_{ₘ}) under the parameter θ_{Q}_{ₘ}, and E[ ] represents an expected calculation value;
g) inputting sₘ(t) to the estimation Actor network to obtain aₘ(t)=πₘ(sₘ(t);θ_{π}_{ₘ}); and inputting sₘ(t+1) to the target Actor network to obtain aₘ(t+1)=πₘ′(sₘ (t+1);θ_{π}_{ₘ}′), wherein πₘ′ represents the strategy to take the action aₘ(t+1), and θ_{π}_{ₘ}′ represents the parameter of the target Actor network;
h) computing

$${∇}_{{θ}_{{π}_{m}}} L ( {θ}_{{π}_{m}} ) \approx E [ {∇}_{{θ}_{{π}_{m}}} log {π}_{m} ( {s}_{m} ( t ) ; {θ}_{{π}_{m}} ) {Q}_{m} ( S , A ; {θ}_{{Q}_{m}} ) ] ,$$

and updating the parameter θ_{π}_{ₘ}, wherein [symbol] represents the random gradient descent computation of the loss function L(θ_{π}_{ₘ}) under the parameter θ_{π}_{ₘ};
i) updating θ_{π}_{ₘ}′ and θ_{Q}_{ₘ}′ according to θ_{Q}_{ₘ}′=ηθ_{Q}_{ₘ}+(1−η)θ_{Q}_{ₘ}′ and θ_{π}_{ₘ}′=ηθ_{π}_{ₘ}+(1−η)θ_{π}_{ₘ}′, wherein η∈[0,1] represents the update rate of the parameter;
j) repeating and iterating steps a)-i) to preset training times to obtain the trained experience pool and the neural network model parameters θ_{Q}_{ₘ} and θ_{π}_{ₘ} as the offline centralized training results of the digital twin.

6) Online distributed execution of task offloading and computation and communication resource allocation are performed by end devices.

Performing online distributed execution of wireless communication and task offloading by end devices to collaboratively process the heterogeneous tasks according to the strategy for minimization of the total task delay comprises the following steps:
a) downloading the training results of the digital twin by all the agents, and inputting the training results into the neural networks of the agents;
b) perceiving an environment by all agents to obtain respective states, computing respective rewards according to the trained neural network model parameters, and executing actions online in a distributed mode, wherein after the state Sₘ(t) of the agent m is inputted to the target Actor network, the action aₘ(t) is outputted according to the reward rₘ(t), that is, the matching decision result of the computation types, the task offloading ratio, the device transmission power and the computation resource allocation result of the end device m and N edge servers;
c) performing task offloading and collaborative computing by all end devices according to the output actions of respective neural networks, that is, the scheduling results of the heterogeneous tasks and resources.

1. A digital twin-based edge-end collaborative scheduling method for heterogeneous tasks and resources, characterized by achieving collaborative scheduling of heterogeneous tasks and heterogeneous computation and communication resources based on multi-agent deep reinforcement learning, and comprising the following steps:
1) establishing an edge wireless network based on digital twin;
2) constructing an edge-end collaborative scheduling problem of heterogeneous tasks and resources according to the deadline requirements of the heterogeneous tasks and the constraints of the heterogeneous computation and communication resources;
3) converting the scheduling problem into a multi-agent Markov decision process problem;
4) constructing an Actor-Critic neural network model based on the multi-agent deep reinforcement learning to solve the multi-agent Markov decision process problem;
5) performing offline centralized training of the Actor-Critic neural network model by digital twin to obtain an experience pool and neural network parameters;
6) perceiving an environment state online by end devices, and performing distributed execution of task offloading and computation and communication resource according to the Actor-Critic neural network model under centralized training to collaboratively process the heterogeneous tasks and minimize the total task processing delay.

2. The edge-end collaborative scheduling method for heterogeneous tasks and resources based on digital twin according to claim 1, characterized in that the edge wireless network based on digital twin comprises: N base stations configured with edge server and M end devices;
The base stations are configured with the edge servers and used for providing computation resources for a plurality of end devices and supporting scheduling of the end devices within a coverage range;
The end devices are used for computing the heterogeneous tasks locally, and supporting offloading of the heterogeneous tasks to the edge server through a wireless channel for edge computing;
The digital twin is placed on a cloud server of the network, represented as a virtualization model established by the base stations and the end devices comprised in the network, and used for evaluating the operating states of the base stations, the edge server and the end devices, the types of the computation resources, and the amount of the computation and communication resources, and supporting the training of a deep reinforcement learning method to carry out the edge-end collaborative scheduling of the network.

3. The edge-end collaborative scheduling method for heterogeneous tasks and resources based on digital twin according to claim 2, characterized in that for a single end device, the tasks can be non-offloaded, partially offloaded, or completely offloaded to one or more edge servers for computing;
The transmission rate of the end device during task offloading is
$${R}_{m , n} = {W}_{m , n} {log}_{2} ( 1 + \frac{{p}_{m} {g}_{m , n}}{{\sum }_{{m}^{′} = 1 , {m}^{′} \neq m}^{M} {p}_{{m}^{′}} {g}_{{m}^{′} , n} + {σ}_{n}^{2}} )$$
wherein W_{m,n} represents the bandwidth between the end device m and the edge server n, σₙ² represents the noise at the edge server n, g_{m,n} and g_{m′,n} represent channel power gains from the end device m and the end device m′ to the edge server n respectively; and pₘ and P_{m′} represent the transmit power of the end device m and the end device m′ respectively.

4. The edge-end collaborative scheduling method for heterogeneous tasks and resources based on digital twin according to claim 1, characterized in that the edge-end collaborative scheduling problem of the heterogeneous tasks and resources is
$${min}_{U , V , P , F} {\sum }_{m = 1}^{M} {T}_{m} ,$$
$$s . t . C 1 : {\sum }_{n = 0}^{N} {v}_{m , n} = 1 ,$$
$$C 2 : 0 \leq {p}_{m} \leq {P}_{max} ,$$
$$m = 1 , … M ,$$
$$C 3 : {p}_{m} \leq \frac{{I}_{p} - {\sum }_{{m}^{′} = 1 , {m}^{′} \neq m}^{M} {p}_{{m}^{′}} {g}_{{m}^{′} , {m}^{*}}}{{g}_{m , {m}^{*}}} ,$$
$$C 4 : {u}_{m , n} = \{ \begin{matrix}1 , if {o}_{n} ⊗ {o}_{m} = 0 , \\ 0 , if {o}_{n} ⊗ {o}_{m} = 1 ,\end{matrix}$$
$$C 5 : 0 \leq {f}_{m , n} + Δ {f}_{m , n} \leq {F}_{max , n} ,$$
$$C 6 : {\sum }_{m = 1}^{M} {u}_{m , n} ( {f}_{m , n} + Δ {f}_{m , n} ) \leq {F}_{max , n} ,$$
$$C 7 : {T}_{m} \leq {T}_{max , m}$$
wherein
$${min}_{U , V , P , F} {\sum }_{m = 1}^{M} {T}_{m}$$
is the target of the problem, which represents minimization of the total task processing delay; Tₘ represents the task processing delay of the end device m; U, V, P and F are the sets of variables to be optimized in the problem, and represent the matching decision of the computation resource types, task offloading ratio, the transmit power of the end device and the computation resource allocation of the edge server respectively;
C1 is the constraint of the task offloading ratio; wherein v_{m,n} ∈[0,1] is the task offloading ratio of the end device m to the edge server n; v_{m,n}=0 represents that the end device m does not offload tasks to the edge server n; v_{m,n}=1 represents that the end device m offloads tasks to the edge server n; v_{m,0}=0 represents that the end device m does not perform local computing; and v_{m,0}=1 represents that the end device m performs local computing;
C2 and C3 are the constraints of the transmit power of the end devices; wherein Pₘₐₓ represents the maximum transmit power of the end device; Iₚ represents the peak interference power that the end device can tolerate; and g_{m,m*} and g_{m′,m*} represent the channel gains from the end device m and the end device m′ to the end device m* respectively; wherein m*=arg max g_{m,m′} is the end device that generates the biggest interference with the end device m;
C4 is the matching decision constraint of the heterogeneous computation resource type; wherein oₘ and oₙ represent the computation resource types of the end device m and the edge server n respectively; ⊗ represents XOR operation; u_{m,n}=1 represents that the computation resource types of the end device m and the edge server n are the same; u_{m,n}=0 represents that the computation resource types of the end device m and the edge server n are different;
C5 and C6 are computation resource constraints; wherein f_{m,n} represents an edge computation resource estimated by the digital twin; Δf_{m,n} represents the computation resource estimation deviation of the digital twin; F_{max,n} represents the maximum computation rate of the edge server n;
C7 is a task deadline constraint; wherein T_{max,n} represents the deadline of the task executed by the end device m, that is, the longest task processing delay that can be accepted by the end device m.

5. The edge-end collaborative scheduling method for heterogeneous tasks and resources based on digital twin according to claim 4, characterized in that the task processing delay of the end device is determined by the edge computing delay Tₘ^{Edge} and the local computing delay Tₘ^{Local}, and a computation method is as follows:
$${T}_{m} = max ( {T}_{m}^{Edge} , {T}_{m}^{Local} )$$
The edge computing delay Tₘ^{Edge} is computed as
$${T}_{m}^{Edge} = {max}_{n = 1 , … , N} \{ {u}_{m , n} {T}_{m , n}^{Edge} \}$$
wherein T_{m,n}^{Edge} represents the edge computing delay of the edge server n for the end device m, which is determined by the communication delay T_{m,n}^{Comm} of task offloading and the computing delay T_{m,n}^{Comp} of task processing, and computed as
$${T}_{m , n}^{Edge} = {T}_{m , n}^{Comm} + {T}_{m , n}^{Comp}$$
The communication delay T_{m,n}^{Comm} of task offloading is determined by the task offloading amount and the offloading rate of the end device, and computed as
$${T}_{m , n}^{Comm} = \frac{{v}_{m , n} {D}_{m}}{{R}_{m , n}}$$
wherein Dₘ represents the task size of the end device m;
The computing delay T_{m,n}^{Comp} of the task processing is determined by the task offloading amount of the end device m and the computation resources n allocated by the edge server m for the end device f_{m,n}, and calculated as
$${T}_{m , n}^{Comp} = {\tilde{T}}_{m , n}^{Comp} + Δ {T}_{m , n}^{Comp}$$
\tilde{T}_{m,n}^{Comp} is the edge computing delay estimated by the digital twin, and calculated as
$${\tilde{T}}_{m , n}^{Comp} = \frac{{v}_{m , n} {D}_{m} {C}_{m}}{{f}_{m , n}}$$
wherein Cₘ represents a computation period required to compute a 1-byte task;
ΔT_{m,n}^{Comp} is the deviation between the computed delay and the estimated delay, and calculated as
$$Δ {T}_{m , n}^{Comp} = - \frac{{v}_{m , n} {D}_{m} {C}_{m} Δ {f}_{m , n}}{{f}_{m , n} ( {f}_{m , n} + Δ {f}_{m , n} )}$$
The local computing delay Tₘ^{Local} is calculated as
$${T}_{m}^{Local} = {\tilde{T}}_{m}^{Comp} + Δ {T}_{m}^{Comp}$$
\tilde{T}ₘ^{Comp} is the local computing delay estimated by the digital twin, and calculated as
$${\tilde{T}}_{m}^{Comp} = \frac{{v}_{m , 0} {D}_{m} {C}_{m}}{{f}_{m}}$$
wherein fₘ=F_{max,m}−Δfₘ represents the local computation resource;
ΔTₘ^{Comp} is the local computing delay deviation, and calculated as
$$Δ {T}_{m}^{Comp} = - \frac{{v}_{m , 0} {D}_{m} {C}_{m} Δ {f}_{m}}{{f}_{m} {F}_{max , m}} .$$

6. The edge-end collaborative scheduling method for heterogeneous tasks and resources based on digital twin according to claim 1, characterized in that converting the optimization scheduling problem into a multi-agent Markov decision process problem comprises the following steps:
a) establishing a multi-agent Markov decision model, comprising an agent set, a state space, an action space, a state transfer probability and a reward function;
The agent set is an agent set M={1, . . . ,M}formed by M end devices;
The state space is a state of the agent m at time t, expressed as
$${s}_{m} ( t ) = \{ {D}_{m} ( t ) , {C}_{m} ( t ) , {T}_{max , m} ( t ) , Δ {f}_{m} ( t ) , {Δ}_{m}^{Edge} ( t ) , {W}_{m} ( t ) , {G}_{m} ( t ) \}$$
wherein Dₘ(t) represents the task size of the end device m; Cₘ(t) represents the number of computing cycles required by the end device m; T_{max,m}(t) represents the task deadline of the end device m; Δfₘ(t) represents the estimation deviation of the local computation resources of the end device m; Δₘ^{Edge}(t)={Δf_{m,1}(t), . . . , Δf_{m,n}^{(t)}} represents the computation resource estimation deviation for N edge servers of the end device m; Wₘ(t)={W_{m,1}(t), . . . , W_{m,N}(t)} and Gₘ(t)={g_{m,1}(t), . . . , g_{m,N}(t)} represent the bandwidth and the channel gain between the end device m and N edge servers respectively; the total state space of all agents in time t is s(t)={s₁(t), . . . S_{M}(t)};
The action space is an action performed by the agent m at time t, expressed as
$${a}_{m} ( t ) = \{ {u}_{m} ( t ) , {v}_{m} ( t ) , {p}_{m} ( t ) , {f}_{m} ( t ) \}$$
wherein uₘ(t)={u_{m,1}(t), . . . u_{m,N}(t)}represents the matching decision of the computation resource types to judge whether the computation resource types of the edge servers are consistent with that of the end device m; vₘ(t)={v_{m,0}(t), v_{m,1}(t), . . . , v_{m,N}(t)} represents the ratio of task offloading processed between the end device m and N edge servers; pₘ(t) represents the transmit power of the end device m for task offloading; fₘ (t)={f_{m,1}(t), . . . , f_{m,N}(t)} represents the computation resources allocated by N edge servers for the end devices m; the total action space of all agents at time t is a(t)={a₁(t), . . . a_{M} (t)};
The state transfer probability is the probability transferred by sₘ(t) to sₘ(t+1) when the agent m executes an action aₘ(t), that is, zₘ(sₘ(t+1);sₘ(t),aₘ(t));
The reward function is the reward or punishment for the agent to take the action in a certain set state, expressed as rₘ(t); wherein the individual reward obtained by the agent m is rₘ(t)=rₘ^{Latency}(t)+ρₘrₘ^{DDL}(t), and ρₘ represents a weight parameter set according to the deadline requirement of the heterogeneous tasks; the delay reward is rₘ^{Latency}(t)=−Tₘ(t) and the deadline reward is rₘ^{DDL}(t)=T_{max,m}(t)−Tₘ(t);
b) determining a long-term cumulative reward function as
$${R}_{m} ( t ) = {\sum }_{{t}_{0} = 0}^{t} {γ}_{m}^{{t}_{0}} {r}_{m} ( {t}_{0} )$$
wherein t represents the current time, t₀ represents the previous time, and γₘ ∈[0,1]represents a discount coefficient for indicating the influence of past rewards on the current rewards of the agent m;
c) converting the problem into
max Rₘ(t)
s.t. C1, C2, C3, C4, C5, C6
In the case that the constraints C1-C6 are satisfied, the long-term cumulative reward is maximized to obtain the best state transfer probability, and then obtain the strategy of minimizing the total task processing delay.

7. The edge-end collaborative scheduling method for heterogeneous tasks and resources based on digital twin according to claim 1, characterized in that constructing an Actor-Critic neural network model based on the multi-agent deep reinforcement learning comprises an Actor network and a Critic network;
the Actor network adopts strategy-based deep neural networks, comprising an estimation Actor network for training and a target Actor network for executing the action to generate agent actions;
the Critic network adopts value-based deep neural networks, comprising an estimation Critic network and a target Critic network to evaluate the actions of the Actor and guide the Actor to produce better actions.

8. The edge-end collaborative scheduling method for heterogeneous tasks and resources based on digital twin according to claim 1, characterized in that performing offline centralized training of the neural network model by digital twin comprises the following steps:
a) inputting sₘ(t) to the estimation Actor network to obtain aₘ(t)=πₘ(sₘ(t);θ_{π}_{ₘ}), wherein πₘ represents the strategy to take action aₘ(t), and θ_{π}_{ₘ} represents a parameter of the estimation Actor network;
b) in state sₘ(t), executing the action aₘ(t), and computing the reward rₘ(t) to obtain sₘ(t+1);
c) (sₘ (t),aₘ(t),rₘ(t),sₘ (t+1)) as an experience is stored in the experience pool for playback as the experience;
d) extracting the experience randomly from the experience pool, inputting S and A to the estimation Critic network, and computing the Q value Qₘ(S, A;θ_{Q}_{ₘ}) of the agent m; inputting S′ and A′ to the target Critic network, and computing the Q value Qₘ′(S′,A′;θ′_{Q}_{ₘ}) of the agent m at the next time, wherein S and S′ represent the state of all the agents and the state of the next time respectively; A and A′ represent the action of all the agents and the action of the next time respectively; and θ_{Q}_{ₘ} and θ′_{Q}_{ₘ} represent the parameters of the estimation Critic network and the target Critic network respectively;
e) computing a temporal difference error δ and a loss function L(θ_{Q}_{ₘ});
f) computing
$${∇}_{{θ}_{{Q}_{m}}} L ( {θ}_{{Q}_{m}} ) = E [ 2 δ {∇}_{{θ}_{{Q}_{m}}} {Q}_{m} ( S , A ; {θ}_{{Q}_{m}} ) ] ,$$
and updating the parameter θ_{Q}_{ₘ}, wherein [symbol] represents the random gradient descent computation of the loss function L(θ_{Q}_{ₘ}) under the parameter θ_{Q}_{ₘ}, and E[ ] represents an expected calculation value;
g) inputting sₘ(t) to the estimation Actor network to obtain aₘ(t)=πₘ (sₘ(t)θ_{π}_{ₘ}); and inputting sₘ(t+1) to the target Actor network to obtain aₘ(t+1)=πₘ′(sₘ(t+1);θ_{π}_{ₘ}′, wherein ζₘ′ represents the strategy to take the action aₘ(t+1), and θ_{π}_{ₘ}′ represents the parameter of the target Actor network;
h) computing
$${∇}_{{θ}_{{π}_{m}}} L ( {θ}_{{π}_{m}} ) \approx E [ {∇}_{{θ}_{{π}_{m}}} log {π}_{m} ( {s}_{m} ( t ) ; {θ}_{{π}_{m}} ) {Q}_{m} ( S , A ; {θ}_{{Q}_{m}} ) ] ,$$
and updating the parameter θ_{π}_{ₘ}, wherein [symbol] represents the random gradient descent computation of the loss function L(θ_{π}_{ₘ}) under the parameter θ_{π}_{ₘ};
i) updating θ_{π}_{ₘ}′ and θ_{Q}_{ₘ}′ according to θ_{Q}_{ₘ}′=ηθ_{Q}_{ₘ}+(1−η)θ_{Q}_{ₘ}′ and θ_{π}_{ₘ}′=ηθ_{π}_{ₘ}+(1-η)θ_{π}_{ₘ}′, wherein η∈[0,1] represents the update rate of the parameter;
j) repeating and iterating steps a)-i) to preset training times to obtain the trained experience pool and the neural network model parameters θ_{Q}_{ₘ} and θ_{πm}, as the offline centralized training results of the digital twin.

9. The edge-end collaborative scheduling method for heterogeneous tasks and resources based on digital twin according to claim 1, characterized in that perceiving an environment state online by end devices, and performing distributed execution of task offloading and computation and communication resource allocation according to the Actor-Critic neural network model under centralized training comprises the following steps:
a) downloading the offline centralized training results of the digital twin by all the agents;
b) perceiving an environment by all the agents to obtain respective states, computing respective rewards according to the trained neural network parameters, and executing actions online in a distributed mode, wherein after the state Sₘ(t) of the agent m is inputted to the target Actor network, the action aₘ(t) is outputted according to the reward rₘ(t), that is, the matching decision result of the computation types, the task offloading ratio, the device transmission power and the computation resource allocation result of the end device m and N edge servers;
c) performing task offloading and collaborative computing by all end devices according to the output actions of respective neural networks, that is, the scheduling results of the heterogeneous tasks and resources.
